(19) United States
(12) Patent Application Publication
(10) Pub. No.: US 2014/0075064 A1
(43) Pub. Date: Mar. 13, 2014

(54) INFORMATION PROCESSING DEVICE

(71) Applicant: Renesas Electronics Corporation, Kanagawa (JP)

(72) Inventor: Kiyoshi MINEGISHI, Kanagawa (JP)

(73) Assignee: Renesas Electronics Corporation, Kanagawa (JP)

(21) Appl. No.: 14/025,423

(22) Filed: Sep. 12, 2013

(30) Foreign Application Priority Data
Sep. 12, 2012 (JP) 2012-200225

(51) Int. Cl. G06F 13/40

(52) U.S. Cl. CPC G06F 13/4022
USPC 710/69; 710/316

(57) ABSTRACT

An information processing device includes a first functional section having an external terminal, and a second functional section and a third functional section, which are commonly coupled to the external terminal of the first functional section. The first functional section includes a first internal circuit that is associated with the second functional section, a second internal circuit that is associated with the third functional section, a switch that can select the first internal circuit or the second internal circuit, and a switch control circuit that controls the operation of the switch. While the second functional section is enabled, the switch control circuit controls the switch so that the first internal circuit is coupled to the second functional section. While the third functional section is enabled, the switch control circuit controls the switch so that the second internal circuit is coupled to the third functional section.

### CROSS-REFERENCE TO RELATED APPLICATIONS

The disclosure of Japanese Patent Application No. 2012-200225 filed on Sep. 12, 2012 including the specification drawings, and abstract is incorporated herein by reference in its entirety.

### BACKGROUND

The present invention relates to an information processing device. More specifically, the present invention is preferably applicable to an embedded system having a microcomputer (e.g., smart meter).

A semiconductor integrated circuit described in Japanese Unexamined Patent Publication No. Sho 63 (1988)-137465 has functions of multiple chips for coupling to a central processing unit IC having an input/output terminal for address signal output and data signal input/output. This semiconductor integrated circuit includes an input/output terminal for coupling to the input/output terminal of the central processing unit IC, inputs/outputs of multiple chips to which inputs/outputs of the same type are commonly coupled, and an interface circuit for selectively coupling the input/output terminal to the inputs/outputs for input/output selection purposes.

### SUMMARY

One function is basically assigned to an external terminal of a semiconductor device such as a microcomputer. In some cases, however, a user option may be used to select one of a plurality of functions assigned to a terminal on an individual terminal basis for the purpose of reducing the number of external terminals. Such a function selection is usually made by performing a power-on reset process immediately after power-on. Therefore, the function of a terminal cannot be changed after system startup unless a reset is performed. Thus, the resulting state is the same as a state in which one function is assigned to a terminal.

A technology described in Japanese Unexamined Patent Publication No. Sho 63 (1988)-137465 selectively uses a plurality of chips coupled to a common bus (ADO-AD15), such as a DMAC function chip, an interrupt controller chip, and a timer circuit chip. This technology does not assign a plurality of different functions to one terminal. For example, a digital signal input/output terminal performs a digital signal input/output function, but cannot be used to acquire an analog signal.

Other problems and novel features will become apparent from the following description and from the accompanying drawings.

A representative means for solving the above problem is summarized below.

According to an aspect of the present invention, there is provided an information processing device including a first functional section, a second functional section, and a third functional section. The first functional section has an external terminal. The second and third functional sections are commonly coupled to the external terminal of the first functional section. The first functional section includes a first internal circuit, a second internal circuit, a switch, and a switch control circuit. The first internal circuit exerts a function associated with the second functional section. The second internal circuit exerts a function associated with the third functional section. The switch can select the first internal circuit or the second internal circuit. The switch control circuit controls the operation of the switch. While the second functional section is enabled, the switch control circuit controls the switch so that the first internal circuit is coupled to the second functional section through the external terminal. While the third functional section is enabled, the switch control circuit controls the switch so that the second internal circuit is coupled to the third functional section through the external terminal.

An advantage provided by the representative means for solving the problem is summarized below.

The present invention provides a technology for assigning a plurality of different functions to one external terminal and switching between such functions in a time-division manner.

### BRIEF DESCRIPTION OF THE DRAWINGS

FIG. 1 is a block diagram illustrating an exemplary configuration of an information processing device;

FIG. 2 is a timing diagram illustrating the operations of essential parts of the information processing device shown in FIG. 1;

FIG. 3 is a block diagram illustrating an exemplary configuration of the information processing device;

FIG. 4 is a block diagram illustrating an exemplary configuration of a smart meter to which the information processing device is applied;

FIG. 5 is a block diagram illustrating an exemplary configuration of essential parts shown in FIG. 4;

FIG. 6 is a timing diagram illustrating the operations of essential parts shown in FIG. 5;

FIG. 7 is a block diagram illustrating an exemplary configuration of the essential parts shown in FIG. 4; and

FIG. 8 is a timing diagram illustrating the operations of essential parts shown in FIG. 7.

### DETAILED DESCRIPTION

### 1. Overview of Embodiments

First of all, an embodiment representative of the present invention disclosed in this document will be summarized. The parenthesized reference numerals in the accompanying drawings referred to in the overview of the representative embodiment merely illustrate what is contained in the concept of elements to which the reference numerals are affixed.

[1] An information processing device (10) according to the representative embodiment of the present invention includes a first functional section (1), a second functional section (2), and a third functional section (3). The first functional section has an external terminal (15). The second and third functional sections are commonly coupled to the external terminal of the first functional section. The function of the second functional section is different from the function of the third functional section. The first functional section includes a first internal circuit (11), a second internal circuit (12), a switch (13), and a switch control circuit (14). The first internal circuit exerts a function associated with the second functional section. The second internal circuit exerts a function associated with the third functional section. The switch can select the first internal circuit or the second internal circuit. The switch control circuit controls the operation of the switch. While the second functional section is enabled, the switch control circuit controls the switch so that the first internal circuit is coupled to the second functional section through the external terminal. While the third functional section is enabled, the switch control circuit controls the switch so that the second internal circuit is coupled to the third functional section through the external terminal.

According to the above-described configuration, the second and third functional sections are commonly coupled to the external terminal so that a signal exchange between the first internal circuit and the second functional section and a signal exchange between the second internal circuit and the third functional section can be made in a time-division manner. In other words, the function of the external terminal can be switched in a time-division manner between a function of acquiring an analog signal from the second functional section and a function of exchanging digital data with the third functional section. This eliminates the necessity of separately providing an external terminal for exchanging signals between the first internal circuit and the second functional section and an external terminal for exchanging signals between the second internal circuit and the third functional section. Hence, the number of external terminals of the first functional section can be reduced.

[1] While the second functional section is enabled, the third functional section is held in a high-impedance state as viewed from the external terminal. This ensures that the signal exchange between the first internal circuit and the second functional section is not adversely affected even when the third functional section is coupled to the external terminal.

[3] While the third functional section is enabled, the second functional section is held in a high-impedance state as viewed from the external terminal. This ensures that the signal exchange between the second internal circuit and the third functional section is not adversely affected even when the second functional section is coupled to the external terminal.

[4]The first functional section may be a microcomputer. The second functional section may be a sensor that outputs an analog signal. The third functional section may be a sub-microcomputer that exchanges digital signals with the first functional section.

An analog-to-digital converter for converting an analog signal received from the sensor to a digital signal may be applied to the first internal circuit. An input/output circuit for inputting a digital signal from and outputting a digital signal to the sub-microcomputer may be applied to the second internal circuit.

The information processing device according to another embodiment includes a first functional section (103), a second functional section (107), and a third functional section (108). The first functional section has an external terminal (53). The second and third functional sections are commonly coupled to the external terminal of the first functional section. The first functional section includes an interface section (47), an analog-to-digital converter (41), a switch (56), and a switch control circuit (57). The interface section functions as a master for synchronous serial communication. The analog-to-digital converter converts an input analog signal to a digital signal. The switch can select the interface section or the analog-to-digital converter. The switch control circuit controls the operation of the switch. The second functional section is selected by a slave select signal (SSL) from the interface section to function as a slave for the synchronous serial communication. The third functional section is a sensor that outputs an analog signal. While the slave select signal is enabled, the switch control circuit controls the switch so that the interface section is coupled to the slave through the external terminal. While the slave select signal is disabled, the switch control circuit controls the switch so that the analog-to-digital converter is coupled to the sensor through the external terminal.

According to the above-described configuration, a signal exchange between the interface section and the slave and a signal exchange between the analog-to-digital converter and the sensor can be made in a time-division manner. Therefore, the same operational advantage can be obtained as indicated under −[1] above.

[−7] In the information processing device described under [6] above, the first functional section may further include a second external terminal (52), a second input/output circuit (45), and a second switch (55). The slave and a light-emitting diode (104) are commonly coupled to the second external terminal. The second input/output circuit performs signal input/output. The second switch can select the interface section or the second input/output circuit. While the slave select signal is enabled, the switch control circuit exerts control so that the interface section is coupled to the slave through the second external terminal. While the slave select signal is disabled, the switch control circuit controls the second switch so that the second input/output circuit is coupled to the light-emitting diode through the second external terminal.

According to the above-described configuration, the signal exchange between the interface section and the slave and a signal supply from the second input/output circuit to the light-emitting diode can be made in a time-division manner.

[8] The information processing device according to still another embodiment includes a first functional section (103), a second functional section (110), and a third functional section (109). The first functional section has an external terminal (72). The second and third functional sections are commonly coupled to the external terminal of the first functional section. The first functional section includes an interface section (48) and an analog-to-digital converter (41). The interface section functions as a master for synchronous serial communication based on a serial clock signal. The analog-to-digital converter converts an input analog signal to a digital signal. The first functional section includes a switch (73) and a switch control circuit (80). The switch can select the interface section or the analog-to-digital converter. The switch control circuit controls the operation of the switch. The second functional section functions as a slave for the synchronous serial communication based on a serial clock signal. The third functional section is a sensor that built in a breaker (109). This sensor outputs an analog signal indicative of the status of the breaker. While the serial clock signal is formed, the switch control circuit controls the switch so that the interface section is coupled to the slave through the external terminal. While the serial clock signal is not formed, the switch control circuit controls the switch so that the analog-to-digital converter is coupled to the sensor through the external terminal.

According to the above-described configuration, a signal exchange between the interface section and the slave and a signal exchange between the analog-to-digital converter and the sensor can be made in a time-division manner. Therefore, the same operational advantage can be obtained as indicated under [1] above.

### 2. Details of Embodiments

Embodiments of the present invention will now be described in further detail.

### First Embodiment

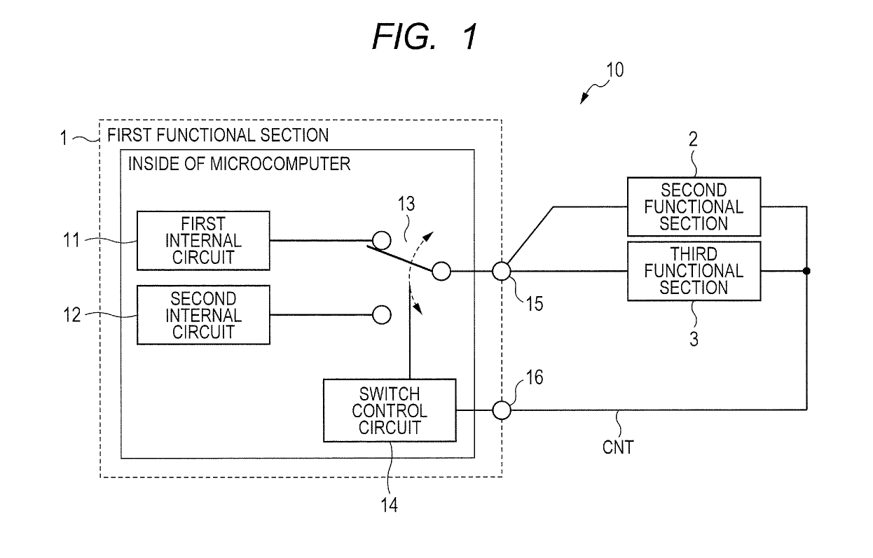

FIG. 1 shows an exemplary configuration of the information processing device.

The information processing device 10 shown in FIG. 1 includes a first functional section 1, a second functional section 2, and a third functional section 3. The first, second, and third functional sections 1, 2, 3 are mounted on a board (not shown). The first functional section 1 is not particularly limited, but is a microcomputer that executes a predetermined program for information processing. Although the first functional section 1 has many external terminals, FIG. 1 shows external terminals 15, 16 as examples. The second and third functional sections 2, 3 are disposed outside the first functional section 1. The second and third functional sections 2, 3 are commonly coupled to the external terminal 15.

The first functional section 1 includes a first internal circuit 11, a second internal circuit 12, a switch 13, and a switch control circuit 14 as internal circuits. The first internal circuit 11 exerts a predetermined function in relation to the second functional section 2. The second internal circuit 12 exerts a predetermined function in relation to the third functional section 3. The switch 13 is coupled to the external terminal 15 to select the first internal circuit 11 or the second internal circuit 12. The selection operation of the switch 13 is controlled by the switch control circuit 14.

The switch control circuit 14 controls the selection operation of the switch 13 in accordance with the logic level of a control signal CNT transmitted from the second functional section 2 or the third functional section 3 through the external terminal 16. The control signal CNT indicates the enabled state or the disabled state of the second and third functional sections 2, 3. While the second functional section 2 is enabled, the switch control circuit 14 controls the selection operation of the switch 13 so that the first internal circuit 11 is coupled to the second functional section 2 through the external terminal 15. While the third functional section 3 is enabled, the switch control circuit 14 controls the switch 13 so that the second internal circuit 12 is coupled to the third functional section 3 through the external terminal 15.

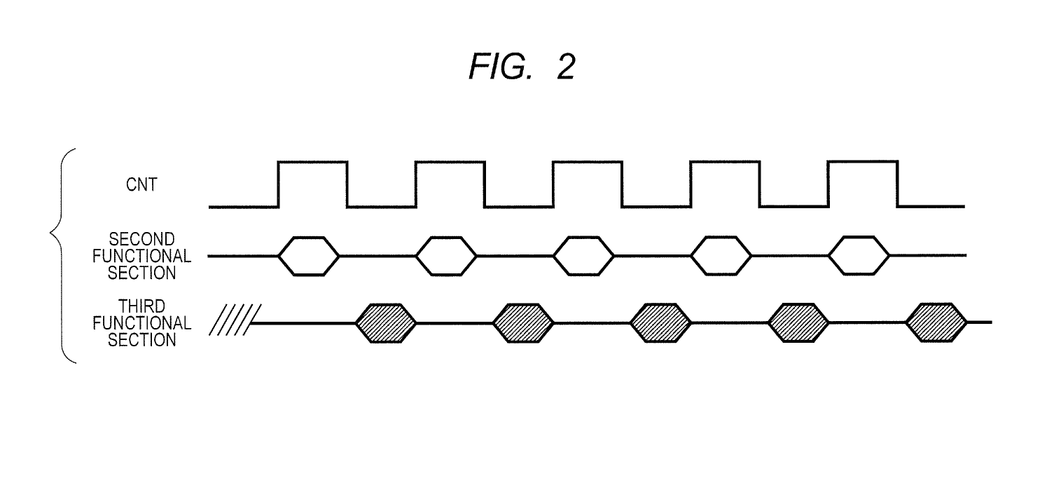

FIG. 2 is a timing diagram illustrating the operations of essential parts of the information processing device 10 shown in FIG. 1.

In the example shown in FIG. 2, the control signal CNT goes high when the second functional section 2 is enabled, and goes low when the third functional section 3 is enabled.

When the control signal CNT is high, the first internal circuit 11 is coupled to the external terminal 15 through the switch 13 under the control of the switch control circuit 14. In this state, the first internal circuit 11 and the second functional section 2 can exchange signals. While the second functional section 2 is enabled, the third functional section 3 is disabled and held in a high-impedance state as viewed from the external terminal 15.

When the control signal CNT is low, the second internal circuit 12 is coupled to the external terminal 15 through the switch 13 under the control of the switch control circuit 14. In this state, the second internal circuit 12 and the third functional section 3 can exchange signals. While the third functional section 3 is enabled, the second functional section 2 is disabled and held in a high-impedance state as viewed from the external terminal 15.

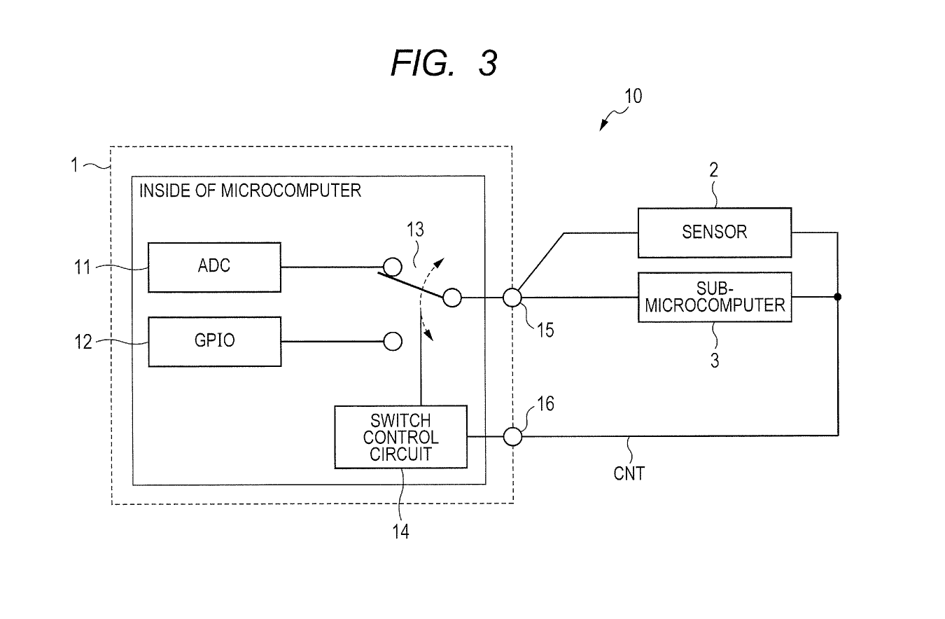

FIG. 3 shows concrete examples of various sections of the information processing device 10 shown in FIG. 1.

According to the exemplary configuration shown in FIG. 3, the second functional section 2 is a sensor that detects, for example, mechanical, electromagnetic, thermal, acoustic, or chemical properties of a natural phenomenon or an artifact and outputs the result of detection in an analog format, and the third functional section 3 is a sub-microcomputer that can exchange digital signals with the first functional section 1. The sub-microcomputer is not particularly limited, but can execute a predetermined program to exert a function of detecting a fault in the first functional section 1 (microcomputer). The first internal circuit 11 is an analog-to-digital converter (ADC) that receives an analog signal from the sensor, which is the second functional section 2, and converts the analog signal to a digital signal. The second internal circuit 12 is a general-purpose input/output circuit (GPIO) that exchanges digital signals with the sub-microcomputer, which is the third functional section 3.

According to the above-described configuration, the ADC 11 is coupled to the external terminal 15 through the switch 13 under the control of the switch control circuit 14 when the control signal CNT is high. In this state, the ADC 11 and the sensor 2 can exchange signals. More specifically, an analog signal output from the sensor 2 is transmitted to the ADC 11 through the external terminal 15 and the switch 13 and converted in the ADC 11 to a digital signal. When, on the other hand, the control signal CNT is low, the GPIO 12 is coupled to the external terminal 15 through the switch 13 under the control of the switch control circuit 14. In this state, the GPIO 12 and the sub-microcomputer 3 can exchange various information.

If the control signal CNT can be formed in the first functional section (microcomputer) 1, the external terminal 16 is not required.

The first embodiment provides the following operational advantages.

(1) The second and third functional sections 2, 3 are commonly coupled to the external terminal 15 so that the signal exchange between the first internal circuit (ADC) 11 and the second functional section (sensor) 2 and the signal exchange between the second internal circuit (GPIO) 12 and the third functional section (sub-microcomputer) 3 can be made in a time-division manner. In other words, the function of the external terminal 15 can be switched in a time-division manner between a function of acquiring an analog signal from the second functional section (sensor) 2 and a function of exchanging digital data with the third functional section (sub-microcomputer) 3.

(2) The operational advantage described under (1) above eliminates the necessity of separately providing an external terminal for exchanging signals between the first internal circuit (ADC) 11 and the second functional section (sensor) 2 and an external terminal for exchanging signals between the second internal circuit (GPIO) 12 and the third functional section (sub-microcomputer) 3. Hence, the number of external terminals of the first functional section (microcomputer) 1 can be reduced.

### Second Embodiment

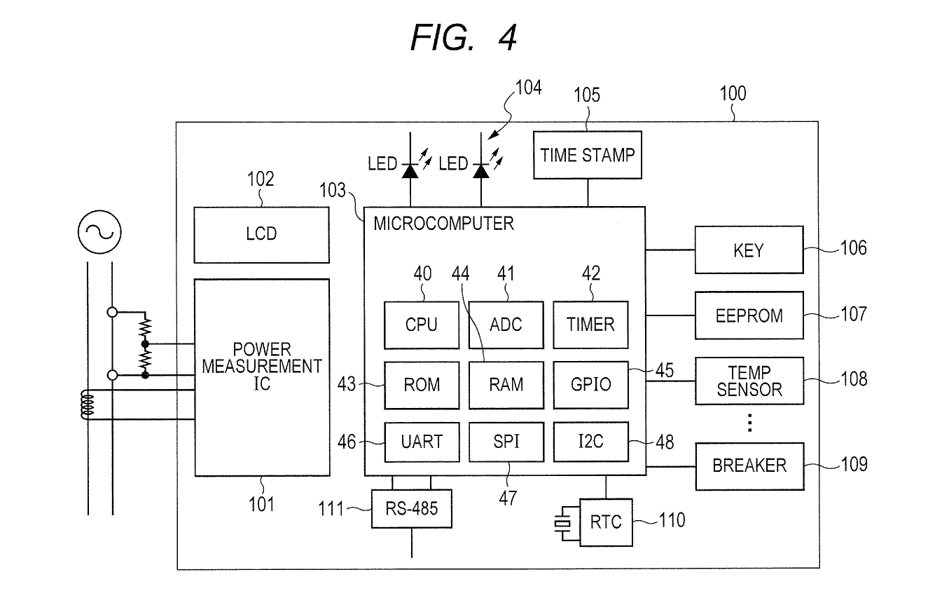

FIG. 4 shows a smart meter to which the information processing device is applied.

The smart meter 100 is a system that includes an electricity meter having a communication function and a function of managing the other devices. When the smart meter 100 is installed in a business facility or in a residence, the use of energy can be grasped in real time.

The smart meter 100 includes a power measurement IC (Integrated Circuit) 101, an LCD (Liquid-Crystal Display) panel 102, a microcomputer 103, an LED (Light-Emitting Diode) 104, a timestamp section (Time Stamp) 105, and a keypad (Key) 106. The smart meter 100 further includes an EEPROM (Electrically Erasable Programmable Read-Only Memory) 107, a temperature sensor (Temp sensor) 108, a breaker 109, a real-time clock (RTC) 110, and a serial communication connector 111.

The power measurement IC 101 is a semiconductor integrated circuit that measures electrical power in accordance with an electrical current flow in wiring. The result of measurement made by the power measurement IC 101 is transmitted to the microcomputer 103. The LCD panel 102 provides a liquid-crystal display of various information. The microcomputer 103 provides overall control of the smart meter 100. The LED 104 illuminates to indicate the status of the smart meter 100 in accordance with a signal output from the microcomputer 103. The timestamp section 105 generates timestamp information that is to be attached to electrical power measurement information generated by the smart meter 100. The keypad 106 is used to enter various information into the smart meter 100. The EEPROM 107 is a nonvolatile memory that stores measurement information generated by the smart meter 100. The temperature sensor 108 detects the internal temperature of the smart meter 100. The breaker 109 automatically shuts off the supply of electricity when electricity is excessively used or when an overcurrent flows due to short-circuiting. This shut-off state is detected by a sensor built in the breaker 109 so that a signal indicative of the result of such detection is transmitted to the microcomputer 103 in an analog format. The transmitted signal causes the microcomputer 103 to grasp the status of the breaker 109. The real-time clock 110 is a semiconductor integrated circuit that dedicatedly functions as a clock. Even when the smart meter 100 is turned off, the real-time clock 110 operates on electrical power supplied from a built-in battery. The serial communication connector 111 establishes serial communication with an external device and complies, for example, with RS-485, which is one of serial communication standards.

The microcomputer 103 includes a CPU (Central Processing Unit) 40, an ADC 41, a timer 42, a ROM (Read Only Memory) 43, and a RAM (Random Access Memory) 44. The microcomputer 103 also includes a GPIO (General Purpose Input/Output) section 45 and a UART (Universal Asynchronous Receiver Transmitter) 46. The microcomputer 103 further includes an SPI (Serial Peripheral Interface) section 47 and an I2C (Inter-Integrated Circuit) section 48.

The CPU 40 performs predetermined arithmetic processing in accordance with a program. The ADC 41 converts an input analog signal to a digital signal. The timer 42 is used for time measurement during the arithmetic processing by the CPU 40. The ROM 43 stores the program to be executed by the CPU 40. The RAM 44 is used, for example, as a work area for the arithmetic processing by the CPU 40. The GPIO section 45 is a general-purpose input/output circuit that can be used for various purposes depending on how it is set up. The UART 46 is a circuit that converts an asynchronous serial signal to a parallel signal and converts a parallel signal to an asynchronous serial signal. The SPI section 47 and the I2C section 48 are synchronous serial communication interface circuits. The SPI section 47 and the I2C section 48 provide faster communication than an asynchronous serial communication standard (RS-232C or other serial communication standard), and can be coupled to a plurality of slaves.

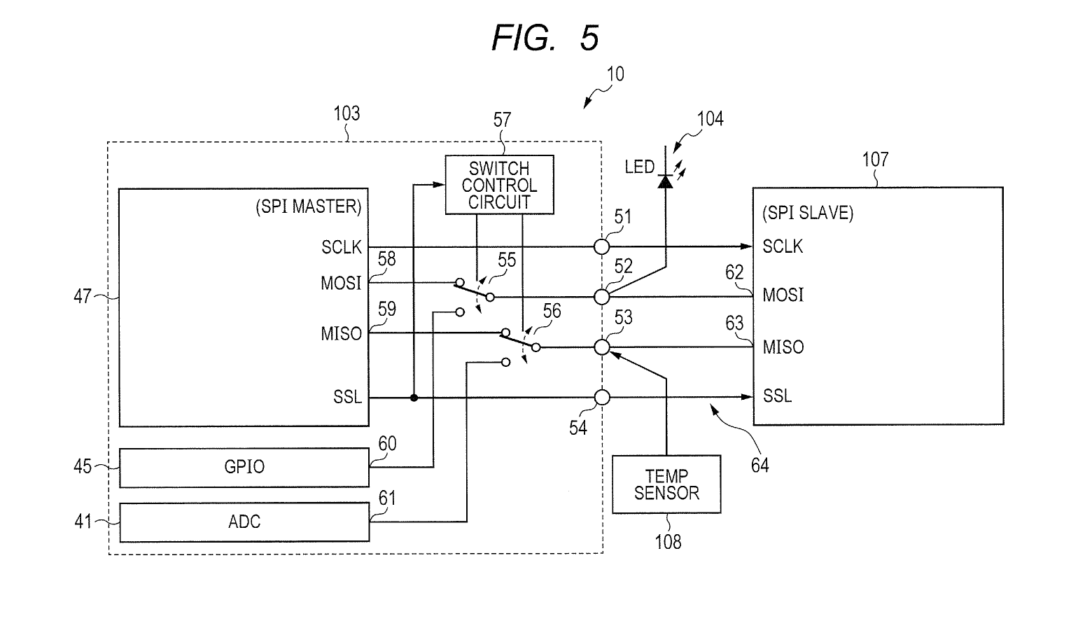

FIG. 5 shows an exemplary configuration of essential parts shown in FIG. 4.

Referring to FIG. 5, the information processing device 10 includes the microcomputer 103, the EEPROM 107, and the temperature sensor 108.

The SPI section 47 in the microcomputer 103 functions as a master (SPI master) for synchronous serial communication. The SPI section 47 is coupled to a plurality of slaves (SPI slaves) through an SPI bus 64. FIG. 5 shows the EEPROM 107 as an example of the slaves coupled to the SPI bus 64. The microcomputer 103 enables a slave select signal SSL in order to select a slave. When, for instance, the slave select signal SSL associated with the EEPROM 107 is enabled, the EEPROM 107 is selected. The SPI section 47 is a three-wire serial interface that handles a serial clock signal SCK, a serial signal MOSI transmitted from the master to a slave, and a serial signal MISO transmitted from a slave to the master. The serial clock signal SCK is supplied to the EEPROM 107 through an external terminal 51 of the microcomputer 103. The serial signal MOSI is supplied to the EEPROM 107 through an external terminal 52 of the microcomputer 103. The serial signal MISO is transmitted to the SPI section 47 in the microcomputer 103 through an external terminal 53 of the microcomputer 103. The slave select signal SSL is supplied to the EEPROM 107 through an external terminal 54 of the microcomputer 103.

A serial signal output terminal 58 of the SPI section 47 and an output terminal 60 of the GPIO section 45 are selectively coupled to the external terminal 52 by a switch 55. The LED 104 and a serial signal input terminal 62 of the EEPROM 107 are commonly coupled to the external terminal 52. Further, a serial signal input terminal 59 of the SPI section 47 and an analog signal input terminal 61 of the ADC 41 are selectively coupled to the external terminal 53 by a switch 56. A serial signal input terminal 63 of the EEPROM 107 and the temperature sensor 108 are commonly coupled to the external terminal 53. The selection operations of the switches 55, 56 are controlled by a switch control circuit 57. While the slave select signal SSL is low (enabled), the switch control circuit 57 causes the switch 55 to select the serial signal output terminal 58 of the SPI section 47 and causes the switch 56 to select the serial signal input terminal 59 of the SPI section 47. While the slave select signal SSL is high (disabled), the switch control circuit 57 causes the switch 55 to select the output terminal 60 of the GPIO section 45 and causes the switch 56 to select the analog signal input terminal 61 of the ADC 41.

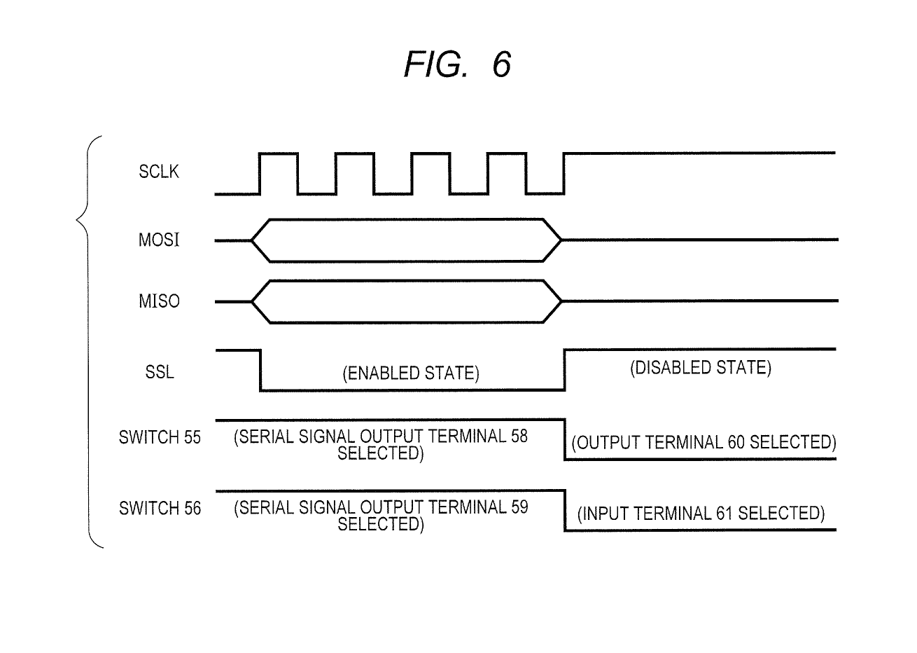

FIG. 6 is a timing diagram illustrating the operations of essential parts shown in FIG. 5.

While the slave select signal SSL is enabled (held low) by the microcomputer 103, the switch 55 selects the serial signal output terminal 58 of the SPI section 47 and the switch 56 selects the serial signal input terminal 59. This establishes synchronous serial communication based on a serial clock signal SCLK between the SPI section 47 in the microcomputer 103 and the EEPROM 107.

While the slave select signal SSL is disabled (held high) by the microcomputer 103, the switch 55 selects the output terminal 60 of the GPIO section 45 and the switch 56 selects the analog signal input terminal 61 of the ADC 41. While the slave select signal SSL is disabled, the supply of the serial clock signal SCLK from the SPI section 47 of the microcomputer 103 to the EEPROM 107 is shut off, and the serial signal input terminals 62, 63 of the EEPROM 107 are held in a high-impedance state. When the switch 55 selects the output terminal 60 of the GPIO section 45, the LED 104 can be driven in accordance with a signal output from the GPIO 45. When the switch 56 selects the analog signal input terminal 61 of the ADC 41, an analog signal from the temperature sensor 108 can be transmitted to the ADC 41. This ensures that the result of temperature detection by the temperature sensor 108 is reflected in the information processing by the microcomputer 103.

According to the second embodiment, the serial signal input terminal 62 of the EEPROM 107 and the LED 104 are commonly coupled to the external terminal 52 and the serial signal input terminal 63 of the EEPROM 107 and the temperature sensor 108 are commonly coupled to the external terminal 53. Further, the switch control circuit 57 controls the selection operations of the switches 55, 56 in accordance with the slave select signal SSL so that synchronous serial communication and the drive of the LED 104 can be provided in a time-division manner through the external terminal 52. Moreover, synchronous serial communication and analog signal acquisition from the temperature sensor 108 can be provided in a time-division manner through the external terminal 53. As the external terminals 52, 53 are used in a time-division manner as described above, the number of external terminals of the microcomputer 103 can be reduced as is the case with the first embodiment.

### Third Embodiment

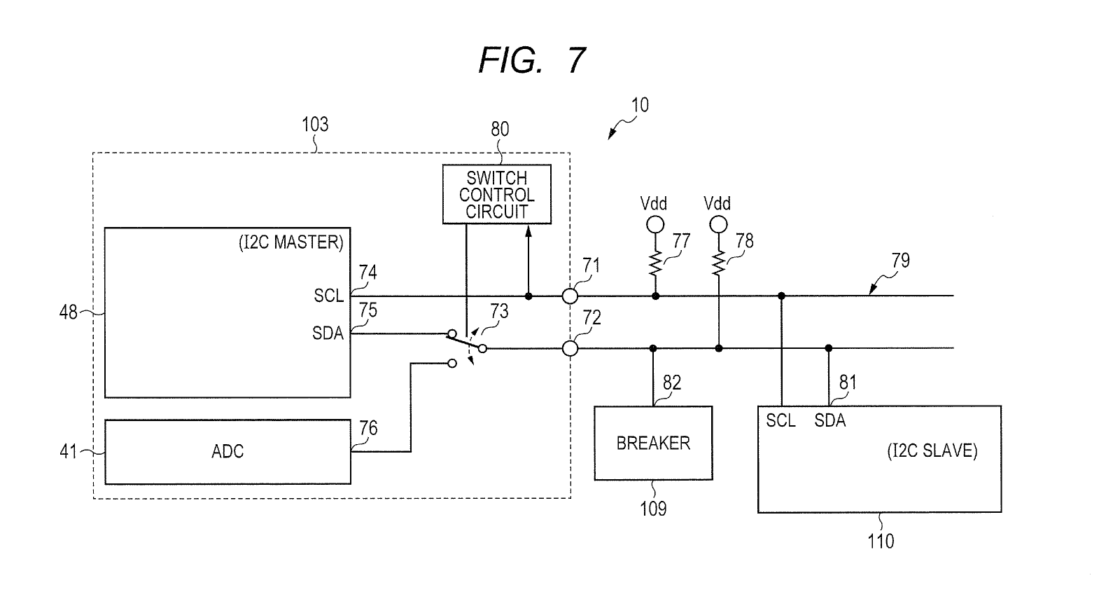

FIG. 7 shows an exemplary configuration of essential parts of the microcomputer 103.

Referring to FIG. 7, the information processing device 10 includes the microcomputer 103, the real-time clock 110, and the breaker 109.

The I2C section 48 in the microcomputer 103 provides synchronous serial communication by using the serial clock signal SCLK and bidirectional serial data SDA. The I2C section 48 functions as a master (I2C master) for the synchronous serial communication. The I2C section 48 is coupled to a plurality of slaves (I2C slaves) through an I2C bus 79. The real-time clock 110 is an example of the slaves coupled to the I2C bus 79. The I2C bus 79 is pulled up to a power supply Vdd by resistors 77, 78. An identification address is set for each slave. An address included in the data of the I2C bus 79 identifies a communication partner to the I2C section 48. In the I2C section 48, the serial clock signal is formed by the master or by a slave when data is to be transferred. While a data transfer is made, an acknowledge signal is returned from a receiving end upon each transfer of one byte of data to let the master and slave verify the data transfer.

A serial clock output terminal 74 of the I2C section 48 is coupled to an external terminal 71 of the microcomputer 103. A serial data input/output terminal 75 of the I2C section 48 and an analog signal input terminal 76 of the ADC 41 are selectively coupled to an external terminal 72 of the microcomputer 103 through a switch 73. A serial data input/output terminal 81 of the real-time clock 110 and an analog signal output terminal 82 of the breaker 109 are commonly coupled to the external terminal 72.

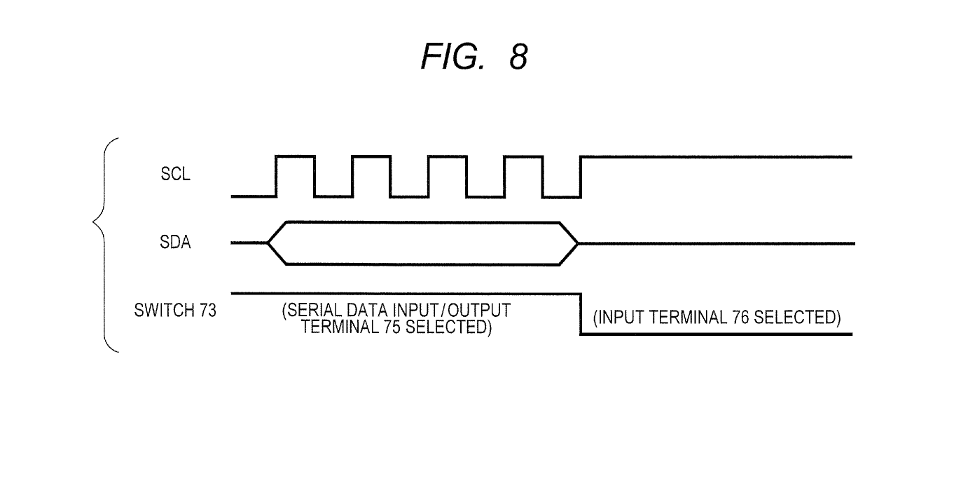

FIG. 8 is a timing diagram illustrating the operations of essential parts shown in FIG. 7.

A switch control circuit 80 monitors a serial clock signal SCL. While the serial clock signal SCL is formed by the I2C section 48 or by the real-time clock 110, the switch control circuit 80 causes the switch 73 to select the serial data input/output terminal 75 of the I2C section 48. This ensures that the serial data SDA can be exchanged between the I2C section 48 and the real-time clock 110.

While the serial clock signal SCL is not formed by the I2C section 48 or by the real-time clock 110, the switch control circuit 80 causes the switch 73 to select the analog signal input terminal 76 of the ADC 41 because the I2C bus 79 is not used. This ensures that an analog signal from the breaker 109 is transmitted to the ADC 41 through the external terminal 72.

As described above, synchronous serial communication by the I2C section 48 and analog signal acquisition from the breaker 109 can be provided in a time-division manner through the external terminal 72. In other words, the external terminal 72 can function to establish synchronous serial communication and acquire an analog signal. Consequently, the third embodiment can reduce the number of external terminals of the microcomputer 103 as compared to a case where an external terminal for synchronous serial communication and an external terminal for analog signal acquisition are separately provided.

While the present invention contemplated by its inventors has been described in detail in terms of preferred embodiments, it is to be understood that the present invention is not limited to those preferred embodiments, but extends to various modifications that nevertheless fall within the spirit and scope of the appended claims.

For example, many functional sections may be provided in addition to the second and third functional sections and commonly coupled to an external terminal. In such an instance, internal circuits associated with the functional sections should be provided in the first functional section separately from the first and second internal circuits so that the coupling to the external terminal is changed as needed with a switch.

What is claimed is:

1. An information processing device comprising:
a first functional section having an external terminal; and
a second functional section and a third functional section, which are commonly coupled to the external terminal of the first functional section,
wherein the first functional section includes:
a first internal circuit, which exerts a function associated with the second functional section;
a second internal circuit, which exerts a function associated with the third functional section;
a switch that can select the first internal circuit or the second internal circuit; and
a switch control circuit that controls the operation of the switch,
wherein, while the second functional section is enabled, the switch control circuit controls the switch so that the first internal circuit is coupled to the second functional section through the external terminal, and wherein, while the third functional section is enabled, the switch control circuit controls the switch so that the second internal circuit is coupled to the third functional section through the external terminal.

2. The information processing device according to claim 1, wherein, while the second functional section is enabled, the third functional section is held in a high-impedance state as viewed from the external terminal.

3. The information processing device according to claim 2, wherein, while the third functional section is enabled, the second functional section is held in a high-impedance state as viewed from the external terminal.

4. The information processing device according to claim 3,
wherein the first functional section is a microcomputer,
wherein the second functional section is a sensor that outputs an analog signal, and
wherein the third functional section is a sub-microcomputer that exchanges digital signals with the first functional section.

5. The information processing device according to claim 4,
wherein the first internal circuit is an analog-to-digital converter that converts an analog signal received from the sensor to a digital signal, and
wherein the second internal circuit is an input/output circuit that inputs a digital signal from and outputs a digital signal to the sub-microcomputer.

6. An information processing device comprising:
a first functional section having an external terminal; and
a second functional section and a third functional section, which are commonly coupled to the external terminal of the first functional section, wherein the first functional section includes:
an interface section that functions as a master for synchronous serial communication;
an analog-to-digital converter that converts an input analog signal to a digital signal;
a switch that can select the interface section or the analog-to-digital converter; and
a switch control circuit that controls the operation of the switch,
wherein the second functional section is selected by a slave select signal from the interface section to function as a slave for the synchronous serial communication,
wherein the third functional section is a sensor that outputs an analog signal,
wherein, while the slave select signal is enabled, the switch control circuit controls the switch so that the interface section is coupled to the slave through the external terminal, and
wherein, while the slave select signal is disabled, the switch control circuit controls the switch so that the analog-to-digital converter is coupled to the sensor through the external terminal.

7. The information processing device according to claim 6, further comprising:
a light-emitting diode,
wherein the first functional section includes:
a second external terminal to which the slave and the light-emitting diode are commonly coupled;
a second input/output circuit that inputs and outputs a signal; and
a second switch that can select the interface section or the second input/output circuit,
wherein, while the slave select signal is enabled, the switch control circuit exerts control so that the interface section is coupled to the slave through the second external terminal, and
wherein, while the slave select signal is disabled, the switch control circuit controls the second switch so that the second input/output circuit is coupled to the light-emitting diode through the second external terminal.

8. An information processing device comprising:
a first functional section having an external terminal; and
a second functional section and a third functional section, which are commonly coupled to the external terminal of the first functional section,
wherein the first functional section includes:
an interface section that functions as a master for synchronous serial communication based on a serial clock signal;
an analog-to-digital converter that converts an input analog signal to a digital signal;
a switch that can select the interface section or the analog-to-digital converter; and
a switch control circuit that controls the operation of the switch,
wherein the second functional section functions as a slave for synchronous serial communication based on a serial clock signal,
wherein the third functional section is a sensor that outputs an analog signal,
wherein, while the serial clock signal is formed, the switch control circuit controls the switch so that the interface section is coupled to the slave through the external terminal, and
wherein, while the serial clock signal is not formed, the switch control circuit controls the switch so that the analog-to-digital converter is coupled to the sensor through the external terminal.
